(19) United States
(12) Patent Application Publication
(10) Pub. No.: US 2002/0179037 A1
(43) Pub. Date: Dec. 5, 2002

(54) Combustion motor

(76) Inventor: Edmund F. Nagel, Feldkirch (AT)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 09/970,526

(22) Filed: Oct. 3, 2001

(30) Foreign Application Priority Data
Oct. 4, 2000 (AT) A 1682/2000

(51) Int. Cl. F04B 17/00; F02B 19/10

(52) U.S. Cl. 123/258; 417/364; 417/298

(57) ABSTRACT

An internal combustion engine comprises a combustion chamber for cyclic combustion of a fuel while forming a combustion gas, a separate expansion chamber which is connected with the combustion chamber by a controllable combustion chamber outlet valve and which has a piston which is mounted so as to be displaceable for converting energy of the combustion gas into mechanical work and energy, and one or more compressor pumps which is/are constructed as piston-cylinder units for filling the combustion chamber with compressed air and which has/have, in each instance, an air inlet valve. The air inlet valve can be throttled and the volume of the cylinder space of the compressor pump or, in case of several compressor pumps, the total volume of the cylinder spaces of the compressor pumps is at least 25%, preferably at least 50%, greater than the volume for filling the combustion chamber with a mixture having an air-fuel ratio of λ=1 with a quantity of fuel to be supplied under full load of the engine.

### CROSS-REFERENCE TO RELATED APPLICATIONS

This application claims priority of Austrian Application No. A 1682/2000, filed Oct. 4, 2000, the complete disclosure of which is hereby incorporated by reference.

### BACKGROUND OF THE INVENTION

a) Field of the Invention

The invention is directed to an internal combustion engine with a combustion chamber for cyclic combustion of a fuel while forming a combustion gas, with a separate expansion chamber which is connected with the combustion chamber by a controllable combustion chamber outlet valve and which has a piston which is mounted so as to be displaceable for converting energy of the combustion gas into mechanical work and energy, and with one or more compressor pumps which are/is constructed as piston-cylinder units for filling the combustion chamber with compressed air and which have/has, in each instance, an air inlet valve.

b) Description of the Related Art

Internal combustion engines are known in different embodiment forms, for example, as conventional spark ignition engines or diesel engines. Further, there are known internal combustion engines having an expansion chamber which is separate from the combustion chamber in which the fuel is burned cyclically while forming a combustion gas and which is connected to the combustion chamber via a controllable inlet valve and in which a piston is mounted so as to be displaceable so that the energy of the combustion gas is converted into mechanical energy or work. Internal combustion engines of this type are known, for example, from EP 0 957 250 A2, AT-PS 172 823, CH-PS 202 930, FR-PS 820 750, DE-PS 4 136 223 and U.S. Pat. No. 4,716,720. The advantage of these internal combustion engines consists in particular in that the combustion gas formed during combustion can fully expand in the expansion chamber during the expansion cycle so that the energy of the combustion gas can be better utilized. The filling of the combustion chamber with the fuel-air mixture can be carried out at atmospheric pressure or with compression. The use of an individual compressor pump for the compression of the air in the combustion chambers is already known, e.g., from DE-PS 4 136 223 and U.S. Pat. No. 4,716,720.

In engines of the type mentioned above, just as in conventional spark ignition engines and diesel engines, there is the problem that an air-fuel ratio of at least λ=1 which is required for stoichiometric combustion can not be achieved without special measures at high engine speeds and under full load of the engine due to the inherent throttling action of the inlet valve and air fill path. In conventional spark ignition engines or diesel engines, turbochargers, for example, are used to overcome this problem.

Further, it is known from the internal combustion engine in DE 4 136 223 C1, cited above, to provide a check valve as an air inlet valve in the respective compressor pump, which check valve is pretensioned in closing direction and comprises a valve disk arranged at a valve stem.

### OBJECTS AND SUMMARY OF THE INVENTION

One object of the invention is to provide an internal combustion engine of the type mentioned above in which an air-fuel ratio of at least λ=1 can be achieved in a simple manner in every case even at maximum engine speed. According to the invention, this problem is solved in that the air inlet valve in the compressor pumps can be throttled and in that the volume of the cylinder space of the compressor pump or, in case of several compressor pumps, the total volume of the cylinder spaces of the compressor pumps is at least 25%, preferably at least 50%, greater than the volume for filling the combustion chamber with a mixture having an air-fuel ratio of λ=1 with a quantity of fuel to be supplied under full load of the engine.

In this way, it is ensured that an air-fuel ratio of at least λ=1 can be achieved in every case even at maximum engine speed, namely, without the additional, uneconomical steps that are conventionally provided. If only a smaller quantity of air is needed at lower engine speeds or under partial load, the inlet valve can be throttled in a corresponding manner.

Another object of the invention is to provide an internal combustion engine of the type mentioned above in which the quantity of air introduced into the combustion chamber can be controlled in a simple manner. According to the invention, this object is met in that the air inlet valve which is constructed as a check valve that is pretensioned in closing direction can be throttled and in that the volume of the cylinder space of the compressor pump or, in case of several compressor pumps, the total volume of the cylinder spaces of the compressor pumps is at least 25%, preferably at least 50%, greater than the volume for filling the combustion chamber with a mixture having an air-fuel ratio of λ=1 with a quantity of fuel to be supplied under full load of the engine.

Accordingly, a kind of “air spring” is provided with predetermines the closing force of the valve. The spring constant of this air spring is adjustable. The check valve does not open until the closing force is exceeded by the vacuum present in the cylinder of the compressor pump, and the size of the opening depends upon the closing force predetermined by the air spring in comparison with the vacuum in the cylinder of the compressor pump. Therefore, depending on the closing force, a larger or smaller amount of air is conveyed into the cylinder of the compressor pump during the downward movement of the piston of the compressor pump (i.e., at the bottom dead center of the piston of the compressor pump, there is a larger or smaller vacuum in the cylinder space of the compressor pump) because the check valve has a certain flow resistance also in the opened state depending on the degree of opening, so that the flow of air into the cylinder space of the compressor pump can not be carried out at any velocity. This air quantity is compressed in the combustion chamber during the downward movement of the piston of the compressor pump.

Further advantages and details of the invention are described in the following with reference to the embodiment example shown in the drawing and additional objects of the invention following therefrom.

### BRIEF DESCRIPTION OF THE DRAWINGS

In the drawings:

FIG. 1 shows a schematic view of a preferred embodiment example of an internal combustion engine according to the invention; and

FIG. 2 shows the pressure curve in the expansion chamber.

### DESCRIPTION OF THE PREFERRED EMBODIMENTS

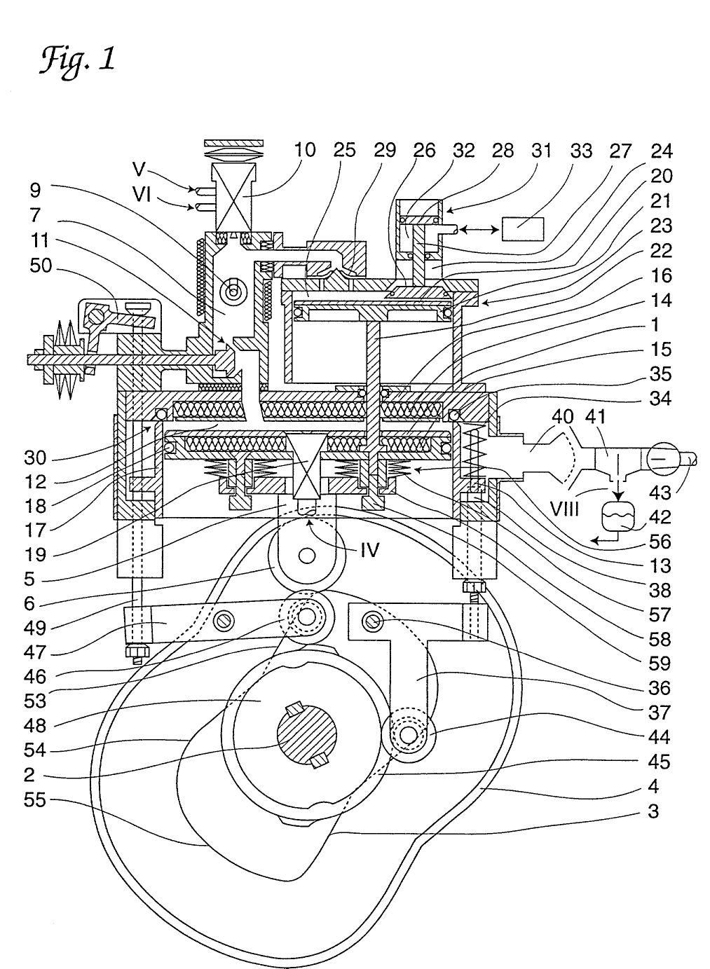

Although only one piston 1 is shown in the schematic view according to FIG. 1, at least two synchronously running pistons 1 acting on the driven shaft 2 from opposite sides are preferably provided. One, two, or more pairs of such pistons 1 which are located opposite one another and are synchronously timed can be provided in respective cylinders. At least the oppositely located pistons, or all of the pistons, can act on the driven shaft 2 along the same inner and outer cam surfaces 3, 4 of the cam drive, which will be described more fully in the following, and independent sliding members in the form of rollers 6 arranged at the piston rods.

At least one combustion chamber 7 is allocated to each piston 1 for cyclic combustion of a fuel. The combustion chamber is surrounded by a jacket of thermally insulating material. The ignition of the fuel-air mixture is carried out by the spark plug 9 only in the startup phase. In continuous operation, the walls of the combustion chamber 7 are heated (to over 700° C.) by the autoignition temperature of the fuel and the fuel is ignited directly when injected into the combustion chamber 7 as it impinges on the walls thereof. Water is preferably injected together with the fuel in order to reduce the combustion temperature which results, in particular, in reduced NOx. The injection nozzles for the fuel and water are shown only schematically in FIG. 1 as a unit 10. The feed of fuel and supply of water are indicated by arrows V and VI, respectively.

The combustion chamber 7 is connected, via a controllable combustion chamber outlet valve 11, to an expansion chamber 12 which is separate from the combustion chamber 7 and which is constructed as a cylinder space in which the piston 1 is mounted so as to be displaceable. In order to prevent heat loss, a thermally insulating layer 14, 15, preferably of ceramic material, is arranged on the inner side of the cylinder head 16 and at the upper side of the piston 1 facing the expansion chamber 12. Only the cylinder wall 17 has no thermal insulation of this kind.

In order to inject water into the expansion chamber 12 for initiating an implosion phase following the expansion phase when the piston 1 has reached the bottom dead center UT, a spray nozzle 19 for water which opens into the expansion chamber 12 is provided. This spray nozzle 19 has a circular nozzle opening or a plurality of nozzle openings arranged along a circumference, so that water is sprayed in the direction of the cylinder wall 17 at a flat angle. This spraying of water also serves to cool the cylinder wall 17 so that a piston seal 18 made of plastic (preferably graphite-Teflon which is resistant to continuous temperatures of up to 250° C.) can be used. A piston seal 18 of this kind can be water-lubricated.

The vacuum forming after the water is sprayed into the expansion chamber reinforces the scavenging of the combustion chamber 7 on the one hand and the piston 1 is accordingly drawn up in the direction of its top dead center OT on the other hand. The piston 1 is connected, via the piston rod 22, to the compressor piston 21 of a compressor pump 23 formed by a piston-cylinder unit. During the downward movement of the piston 1 and of the compressor piston 21 connected with it the air inlet valve 24 which is constructed as an automatic check valve opens and air flows into the cylinder space 25. During the subsequent upward movement of the piston 1 and compressor piston 21, the air outlet valve 29 which is likewise constructed as an automatic check valve opens and air which leads to a corresponding compressor pressure is pushed into the combustion chamber 7. A cushion 20 of deformable material is arranged on the compressor piston 21 so that in the uppermost position of this piston all of the air, which would otherwise act as an “air spring” resulting in unnecessary losses, is pressed out of the cylinder space 25.

The air inlet valve 24 comprises a valve disk 26 which is arranged at a valve stem 27. The valve stem 27 simultaneously forms a piston rod which is connected with a piston 28 and is part of a piston-cylinder unit. The cylinder space 32 of this piston-cylinder unit is filled with air and the air pressure produces a force acting in the closing direction of the air inlet valve 24. To change the closing force of the air inlet valve 24, the air pressure in the cylinder space can be changed by means of a unit 33 comprising an air pump. Accordingly, this air pressure constitutes a kind of air spring whose spring constant can be changed. The air inlet valve opens only after the vacuum in the cylinder space 25 has overcome the closing force of the air inlet valve 24. Due to the limited flow-in velocity of the air through the air inlet valve 24, a vacuum is present when the compressor piston 21 has reached the bottom dead center, which vacuum varies depending on the closing force of the air inlet valve 24. The amount of air introduced into the combustion chamber 7 during the subsequent compressor stroke and, therefore, the compressor pressure can be changed in this way.

While the piston 1 moves from its bottom dead center UT in the direction of its top dead center OT, the mixture of combustion gas and water steam which is initially under vacuum at bottom dead center UT combines in the expansion chamber until its pressure finally increases above atmospheric pressure and it can flow out by the opening of the expansion chamber outlet valve 30.

The expansion chamber outlet valve 30 comprises the cylinder wall 17 which is displaceable in longitudinal direction of the cylinder. In the closed position of the expansion chamber outlet valve 30, the cylinder wall 17 is pressed against a sealing ring 35 arranged in an annular groove in the cylinder head 16, namely, against the force of a spring 34 acting in the opening direction of the expansion chamber outlet valve. In the open position, an annular outlet opening is released. In the present embodiment example, a cam control is provided for acting upon the displaceable cylinder wall 17 in the position in which it is pressed against the sealing ring 35. A cam disk 45 is provided on the shaft 2. A pin which is mounted on a lever 37 that is swivelable about a swivel pin 36 is pressed against a flange 13 of the cylinder wall 17 by means of the cams arranged on the above-mentioned cam disk 45 (these cams extend substantially around the entire cam disk 45 with the exception of two recesses; two cycles of the engine are carried out per revolution of the shaft). When the roller 44 which is arranged at the swivelable lever 37 and runs on the cam disk 45 is located in one of the recesses between the cams, the expansion chamber outlet valve 30 opens due to the force of the spring 34 and the mixture of combustion gas and water can flow out of the expansion chamber 12. It travels along a line segment 40 to a water separator 41 which can be constructed in a manner analogous to the water separator described in EP 0 957 250 A2. The coolant water is returned to the water tank 42 corresponding to arrow VIII and the combustion gas can flow out through the exhaust 43.

The combustion chamber outlet valve 11 is likewise actuated by a cam control. A roller 46 which is mounted at the lever 47 that is swivelable about a lever arm rolls along a cam disk 48. The cams arranged on this cam disk 48 actuate the combustion chamber outlet valve 11 by means of the pin 49, which is connected with the other lever arm of the lever 47, and the lever 50.

Different pump devices of conventional construction can be used for injecting the fuel and the water into the combustion chamber 7 and for spraying water into the expansion chamber, e.g., cam pumps driven by the shaft 2. A roller 6 is mounted so as to be rotatable at the free end of the rod 5 that is acted upon by the piston 1. The distance between the two cam surfaces 3, 4 is somewhat greater than the diameter of the roller 6, so that the roller 6 which acts as a pushing member of the cam drive can roll either on the inner cam surface 3 or on the outer cam surface 4. When the roller 6 rolls on the inner cam surface 3 during the downward movement of the piston 1 from the top dead center to the bottom dead center, energy is supplied to the shaft 2 (by the overpressure of the expanding combustion gas); when the roller 6 rolls on the outer cam surface 4 during the downward movement of the piston, the shaft 2 drives the piston (the combustion gas in the expansion chamber 12 can accordingly be thinned to below-atmospheric pressure as will be explained in the following). During the upward movement of the piston 1 from the bottom dead center in the direction of the top dead center, on the other hand, the energy is supplied to the shaft 2 when the roller 6 rolls on the outer cam surface 4. When the roller 6 rolls along the inner cam surface 3, energy is removed (for example, in case the energy is not sufficient for the compression of the air by the compressor pump 23 because of the vacuum generated in the expansion chamber 12 by the implosion brought about by the injection of water).

The inner cam surface 3 and outer cam surface 4 are each circumferentially closed outer faces. Each cam surface 3, 4 has three portions along its circumference which will be described in the following with reference to the inner cam surface 3. In the first portion 53, the distance between the cam surface and the center of the shaft 2 initially decreases quickly and then more slowly. This portion is associated with the downward movement of the piston from the top dead center to the bottom dead center. The initial quick decrease in distance corresponds to the initial quick reduction in pressure in the expansion chamber. In the subsequent, second portion 54, the distance between the cam surface 3 and the center of the shaft increases again. This portion is associated with the upward movement of the piston from the bottom dead center to the top dead center. Following the second portion 54 is a third portion 55 which has a constant maximum distance 55 from the center of the shaft 2. Therefore, while the roller 6 rolls along this portion 55 of the cam surface, the piston remains stationary at the top dead center OT (“wait phase”). During this period, the combustion of the fuel in the combustion chamber 7 can be carried out completely. The three portions 53, 54, 55 are provided twice along the circumference of the cam surface 3, so that two complete work cycles of the engine are carried out during a complete revolution of the shaft 2. In an analogous manner, the outer cam surface 4 is divided into portions corresponding to portions 53, 54, 55.

A spring device 56 is provided between the piston 1 and the rod 5, which rod 5 is acted upon by the piston 1 and drives the shaft 2 by means of the cam drive described above. This spring device 56 comprises pressure springs 57 which are constructed in this case as disk springs. The pressure springs are arranged between a pressure plate 58 which is fixed to the rod 5 and the back of the piston 1 remote of the expansion chamber 12. At least three pressure springs are provided in order to prevent tilting of the piston 1 during its upward movement in which it drives the compressor piston 21. These three pressure springs are arranged at the comers of an imaginary triangle. In the embodiment example shown here, there are four pressure springs arranged at the comers of an imaginary square. The pressure plate 58 is formed by two intersecting arms. The disk springs 57 are pretensioned by screws 59. Therefore, piston 1 moves relative to the pressure plate 58 only when a force exceeding this pretensioning is exerted on the piston. This in turn prevents a tilting of the piston during its upward movement because of the force acting asymmetrically on the piston 1 due to the compressor piston 21.

In order to prevent asymmetric loading of the piston 1 during its upward movement, the piston rod 22 could act centrally on the piston 1 i.e., it could be aligned with the rod 5 (the combustion chamber 7 would have to be shifted to the side). In this case, an individual central pressure spring 57 between the base of the piston 1 and the rod 5 would be sufficient; the pretensioning of the spring could also be dispensed with.

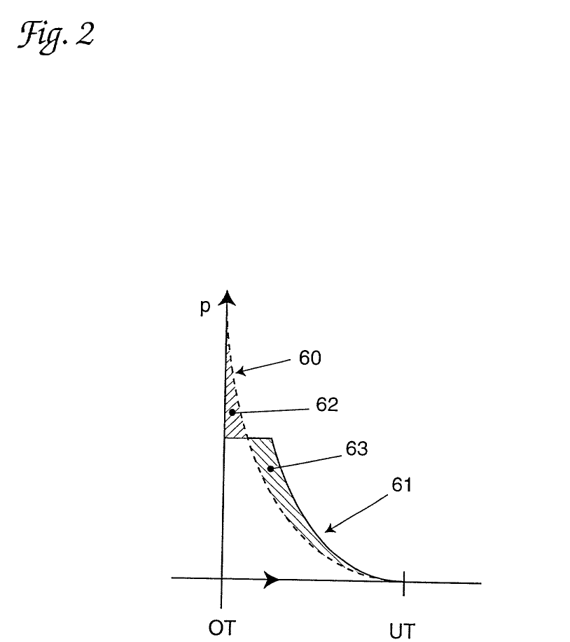

The spring device is designed in such a way that it can absorb the pressure peak exerted on it in a first phase of the downward movement of the piston 1 by the combustion gas after the opening of the combustion chamber outlet valve 11 and stores it as potential energy. The maximum pressure exerted on the rod 5 is accordingly reduced as can be seen from the graph in FIG. 2. The pressure which would be exerted on the rod without the spring device 56 (and which loads the piston 1) is represented by the dashed line 60. The spring device results in the pressure curve corresponding to the solid line 61. The maximum pressure is accordingly substantially smaller. The energy stored by the spring device in the first phase of the downward movement of the piston is shown by the shaded surface 62. In another phase of the downward movement of the piston with a lower pressure of the combustion gas, this stored potential energy is supplied to the rod 5. This supplied energy corresponds to surface 63.

The cycle of the internal combustion engine is carried out in the following manner:

During the upward movement of the piston 1 in the direction of its top dead center OT, fresh air is introduced into and compressed in the combustion chamber 7 by means of the compressor pump 23. As soon as the piston 1 has reached the top dead center OT, or shortly before this, fuel and water are injected into the combustion chamber 7. Ignition is carried out by the spark plug 9 only when cold-starting the internal combustion engine. Further, for cold-starting the engine, the piston 1 is driven via the shaft 2 and the cam drive by means of an electric motor, not shown in the drawing.

After complete burnup of the fuel-air mixture, wherein the piston 1 is still located at its top dead center OT, the expansion chamber outlet valve 30 is closed and the combustion chamber outlet valve 11 is opened. The pressure in the expansion chamber 12 accordingly increases quickly initially and then drops again gradually as the piston 1 runs downward. In full load operation, the pressure in the expansion chamber 12 has just dropped to atmospheric pressure in a preferred operating mode when the piston 1 has reached the bottom dead center UT. In this case, during partial load operation of the engine, atmospheric pressure has already been reached, while the piston 1 is still on its way from the top dead center to the bottom dead center. Subsequently, there is a drop in pressure in the expansion chamber 12 below atmospheric pressure in partial load operation. The combustion gas is accordingly thinned before the implosion phase is initiated. The implosion phase is initiated as soon as the piston 1 has reached the bottom dead center UT in that coolant water is sprayed into the expansion chamber 12. Due to the sudden cooling of the combustion gas, the pressure is further reduced in the expansion chamber 12 which is now below atmospheric pressure also in the case of full load operation of the engine. The piston 1 is drawn upward by this vacuum and now moves from the bottom dead center 1 in the direction of the top dead center. During this movement, the combustion chamber outlet valve 11 is still held open initially so as to enable the charge exchange in the combustion chamber 7. The upward movement of the piston continues, wherein the fresh air in the combustion chamber 7 is compressed and, further, the pressure in the expansion chamber 12 rises in direction of atmospheric pressure. Shortly before the piston 1 reaches the top dead center, the pressure in the expansion chamber 12 rises above atmospheric pressure and the expansion chamber outlet valve 30 is opened, wherein the combustion gas water mixture contained in the expansion chamber 12 is pressed out through the expansion chamber outlet valve 30 (exhaust phase). When the top dead center OT of the piston 1 is reached, or shortly before this, the next ignition of fuel is carried out in the combustion chamber. The piston remains at the top dead center (wait phase) until the fuel is completely burned, whereupon the next expansion phase is initiated by the opening of the outlet valve 11.

In another preferred operating mode, a thinning of the combustion gas to below atmospheric pressure is already provided in full load operation when the piston has reached the bottom dead center.

The volume of the cylinder space 25 of the compressor pump 23 is at least 25%, in a preferred embodiment form at least 50%, greater than the volume for filling the combustion chamber with a mixture whose air-fuel ratio is λ=1, namely, with an amount of fuel to be injected into the combustion chamber 7 under full load of the engine. Accordingly, in connection with the throttled air inlet valve 24 and at low as well as high speeds of the engine, an air-fuel ratio of the mixture in the combustion chamber 7 of at least λ=1 can be achieved. The full load of the engine corresponds to the maximum output at the respective speed for which the engine is designed.

Instead of the throttled air inlet valve 24 described above, a throttled air inlet valve, e.g., in the form of an electromagnetic valve, could also be carried out.

As will be clear from the preceding description, the field of the invention is not limited to the embodiment examples shown herein, but should be defined with reference to the appended claims together with their full scope of possible equivalents. While the preceding description and the drawings show the invention, it is obvious to the person skilled in the art that various modifications may be implemented without departing from the true spirit and field of the invention.

While the foregoing description and drawings represent the present invention, it will be obvious to those skilled in the art that various changes may be made therein without departing from the true spirit and scope of the present invention.

1. Internal combustion engine with a combustion chamber for cyclic combustion of a fuel while forming a combustion gas, with a separate expansion chamber which is connected with the combustion chamber by a controllable combustion chamber outlet valve and which has a piston which is mounted so as to be displaceable for converting energy of the combustion gas into mechanical work and energy, and with one or more compressor pumps (23) which are/is constructed as piston-cylinder units for filling the combustion chamber with compressed air and which have/has, in each instance, an air inlet valve, wherein the air inlet valve (24) can be throttled and the volume of the cylinder space (25) of the compressor pump (23) or, in case of several compressor pumps (23), the total volume of the cylinder spaces of the compressor pumps is at least 25% greater than the volume for filling the combustion chamber (7) with a mixture having an air-fuel ratio of λ=1 with a quantity of fuel to be supplied under full load of the engine.

2. Internal combustion engine according to claim 1, wherein the volume of the cylinder space (25) of the compressor pump (23) or, in case of several compressor pumps (23), the total volume of the cylinder spaces of the compressor pumps is at least 50% greater than the volume for filling the combustion chamber (7) with a mixture having an air-fuel ratio of λ=1 with a quantity of fuel to be supplied under full load of the engine.

3. Internal combustion engine with a combustion chamber for cyclic combustion of a fuel while forming a combustion gas, with a separate expansion chamber which is connected with the combustion chamber by a controllable combustion chamber outlet valve and which has a piston which is mounted so as to be displaceable for converting energy of the combustion gas into mechanical work and energy, and with one or more compressor pumps (23) which are/is constructed as piston-cylinder units for filling the combustion chamber with compressed air and which have/has in each instance, as air inlet valve in the compressor pump, a check valve which is pretensioned in closing direction and which comprises a valve disk arranged at a valve stem, wherein the valve stem (27) is connected with a piston (28) of a piston-cylinder unit (31) having a cylinder space (32) in which an air pressure acts in the closing direction of the air inlet valve, and wherein the air pressure in the cylinder space (32) can be changed in order to change the closing force of the air inlet valve.

4. Method for operating an internal combustion engine with a combustion chamber for cyclic combustion of a fuel while forming a combustion gas, with a separate expansion chamber which is connected with the combustion chamber by a controllable combustion chamber outlet valve and which has a piston which is mounted so as to be displaceable for converting energy of the combustion gas into mechanical work and energy, and with one or more compressor pumps (23) which are/is constructed as piston-cylinder units for filling the combustion chamber with compressed air and which have/has, in each instance, an air inlet valve, wherein the amount of air introduced into the combustion chamber (7) is controlled by means of controlling the air inlet valve (24) that is constructed such that it can be throttled.

5. Method according to claim 4, wherein the volume of the cylinder space (25) of the compressor pump (23) or, in case of several compressor pumps (23), the total volume of the cylinder spaces of the compressor pumps is at least 25%, preferably at least 50%, greater than the volume for filling the combustion chamber (7) with a mixture having an air-fuel ratio of λ=1 with a quantity of fuel to be supplied under full load of the engine.
